(19) United States
(12) Patent Application Publication
(10) Pub. No.: US 2016/0048996 A1
(43) Pub. Date: Feb. 18, 2016

(54) SCHEDULE DISPLAY DEVICE, SCHEDULE DISPLAY METHOD, AND SCHEDULE DISPLAY PROGRAM

(71) Applicant: NEC SOLUTION INNOVATORS, LTD., Tokyo (JP)

(72) Inventor: Yusuke NAKAO, Tokyo (JP)

(21) Appl. No.: 14/778,781

(22) PCT Filed: Jan. 16, 2014
(86) PCT No.: PCT/JP2014/000185

§ 371 Date: Sep. 21, 2015

(30) Foreign Application Priority Data
Mar. 21, 2013 (JP) 2013-058224

(51) Int. Cl. G06T 15/00; G06T 19/20; G06T 15/10; G06Q 10/10

(52) U.S. Cl. CPC G06T 15/005; G06Q 10/1095; G06T 19/20; G06T 15/10; G06T 2200/04

(57) ABSTRACT

A schedule display device includes a display processing unit (2) for displaying a schedule table by use of an image indicating a 3D object on a screen of a portable terminal, and the display processing unit (2) displays schedule items on the front side of the object to be wider width per unit time.

### TECHNICAL FIELD

The present invention relates to a schedule display device, a schedule display method, and a schedule display program, for displaying a schedule.

### BACKGROUND ART

In recent years, portable terminals such as smartphones are generally used. Such portable terminals employ schedule management software for managing schedules. FIG. 8 is an explanatory diagram illustrating an exemplary typical schedule table. A schedule table vertically displaying therein a plurality of items as illustrated in FIG. 8 is employed in typical schedule management software, for example.

Further, Patent Literature 1 discloses therein a schedule display device capable of setting a display form depending on a condition when displaying schedules of periodical plans. Also in Patent Literature 1, a schedule table vertically displaying therein a plurality of items as illustrated in FIG. 8 is employed.

### CITATION LIST

### Patent Literature

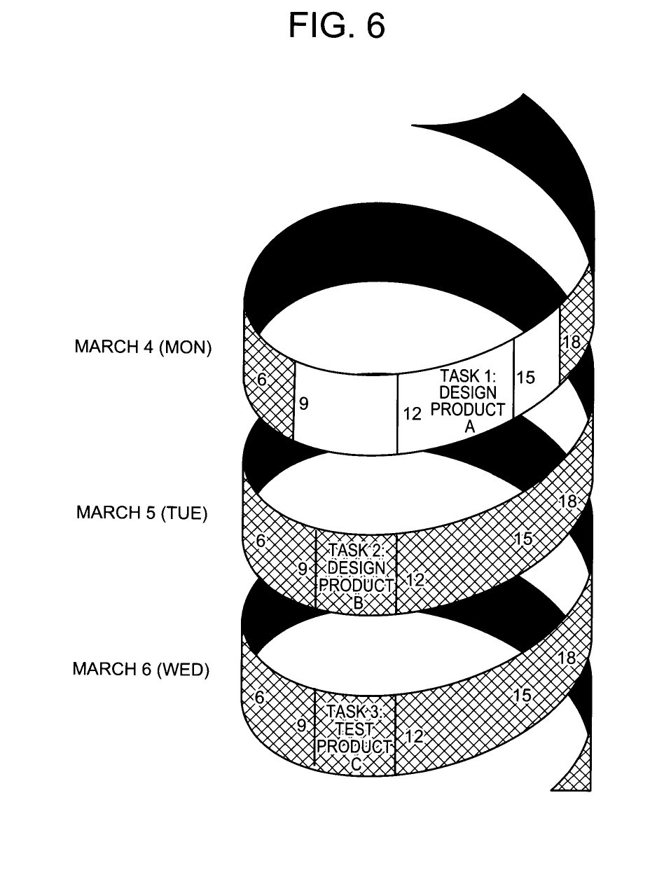

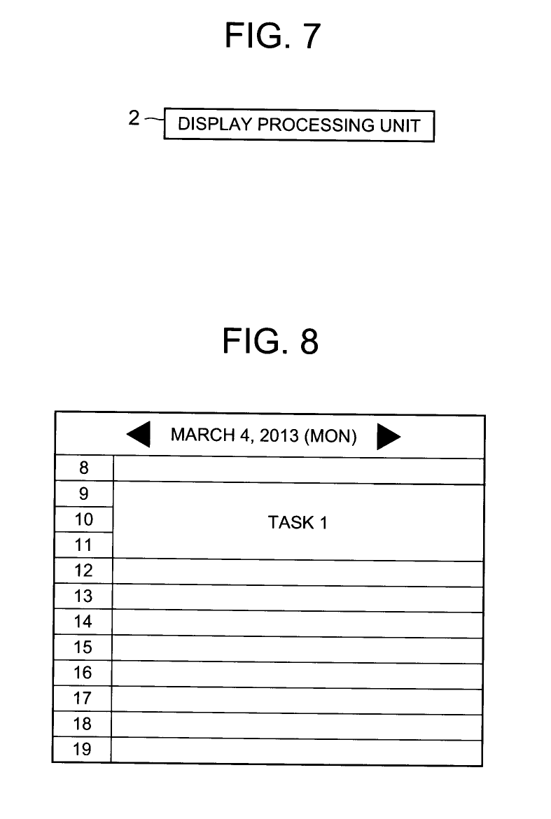

PLT 1: JP 11-219392 A (FIG. 6 and FIG. 7)

### SUMMARY OF INVENTION

### Technical Problem

However, the screen of a portable terminal is smaller than that of a display device used for a desktop PC (Personal Computer), and thus each item in a schedule table is also displayed small. Therefore, there is a problem that the screen is difficult to operate for the user. Especially when operations are performed on a touch panel, erroneous operations easily occur. Further, there is a problem that when each item in a schedule table is displayed large, less information is displayable and listing performance is deteriorated.

It is therefore an object of the present invention to provide a schedule display device capable of displaying a schedule table with high operability and high listing performance, a schedule display method, and a schedule display program.

### Solution to Problem

A schedule display device according to the present invention includes a display processing unit for displaying a schedule table by use of an image indicating a 3D object on a screen of a portable terminal, and the display processing unit displays schedule items on the front side of the object to be wider width per unit time.

A schedule display method according to the present invention displays a schedule table by use of an image indicating a 3D object on a screen of a portable terminal and displaying schedule items on the front side of the object to be wider width per unit time.

A schedule display program according to the present invention causes a computer to perform a display processing of displaying a schedule table by use of an image indicating a 3D object on a screen of a portable terminal and displaying schedule items on the front side of the object to be wider width per unit time.

### Advantageous Effects of Invention

According to the present invention, it is possible to display a schedule table with high operability and high listing performance.

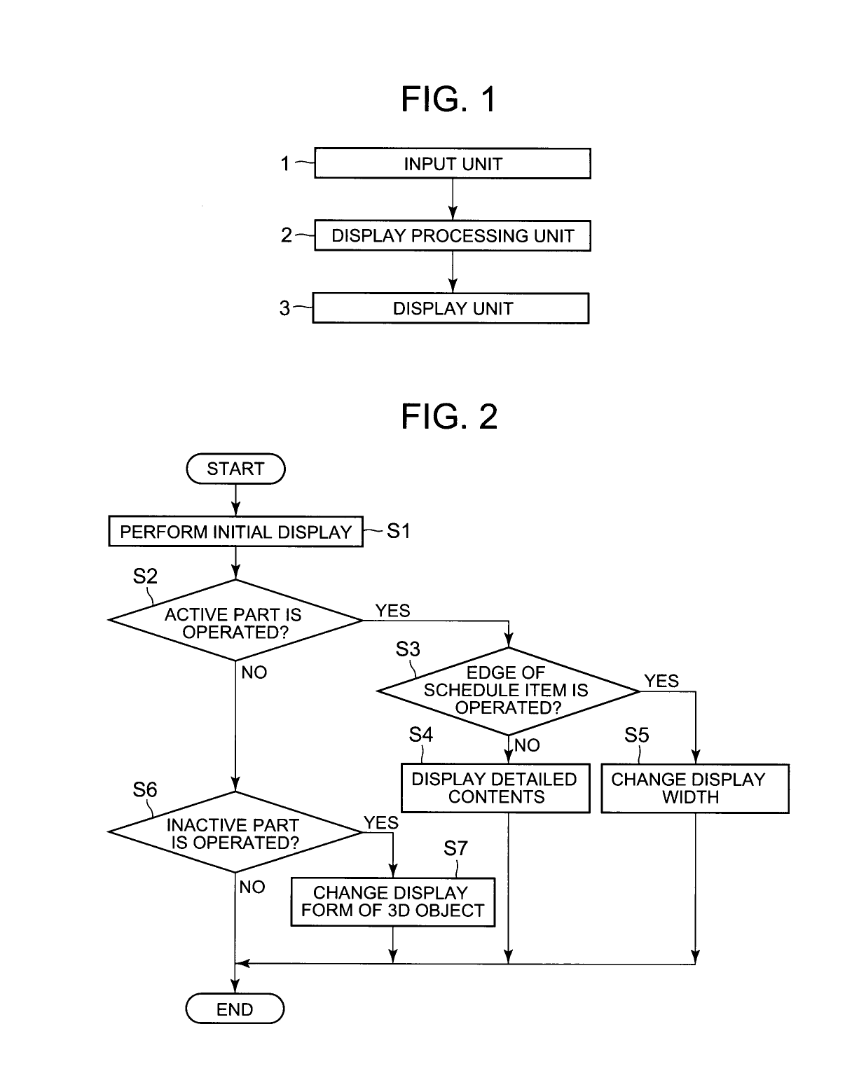

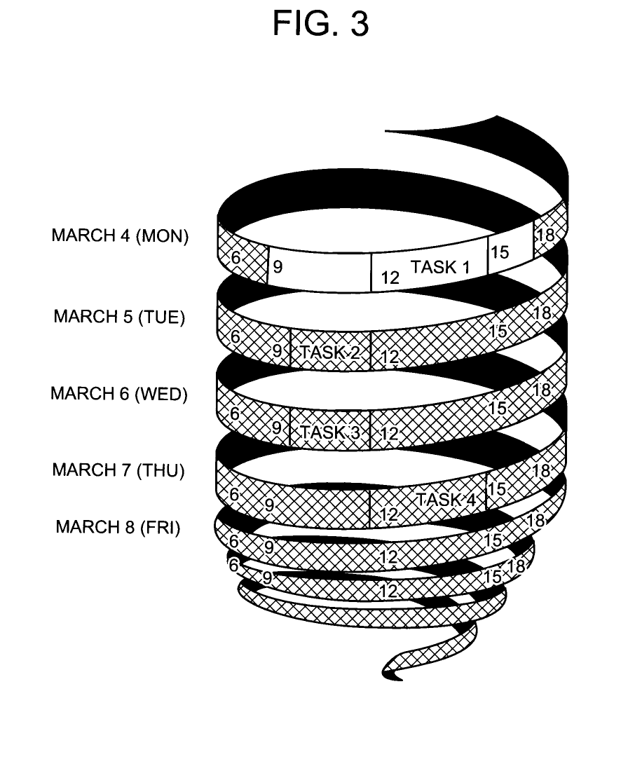

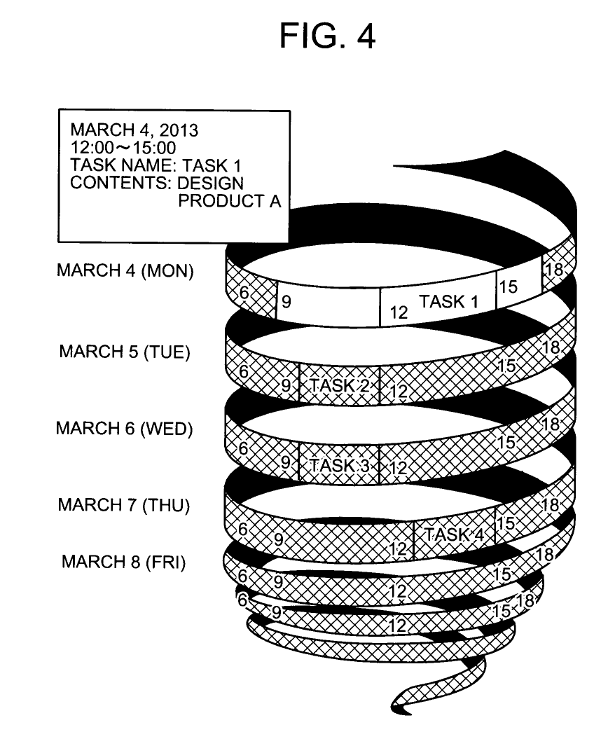

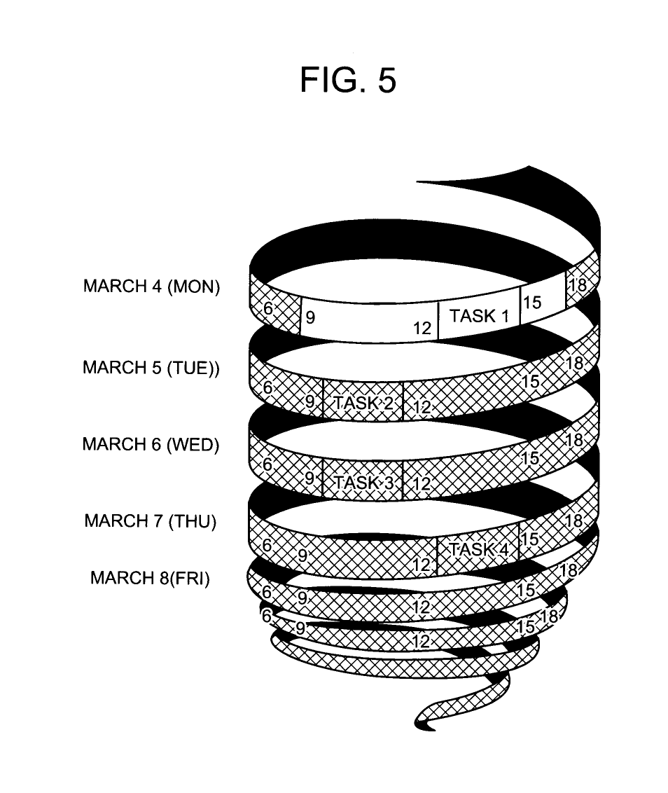

### BRIEF DESCRIPTION OF DRAWINGS

[FIG. 1] It depicts a block diagram illustrating a structure of a schedule display device according to the present invention.

[FIG. 2] It depicts a flowchart illustrating the operations of the schedule display device according to the present invention.

[FIG. 3] It depicts an explanatory diagram illustrating exemplary display of a schedule table.

[FIG. 4] It depicts an explanatory diagram illustrating exemplary display of detailed contents of a schedule.

[FIG. 5] It depicts an explanatory diagram illustrating an exemplary screen in which a schedule time is changed.

[FIG. 6] It depicts an explanatory diagram illustrating an exemplary screen in which the number of stages in the schedule table is changed.

[FIG. 7] It depicts a block diagram illustrating a structure of main components in the schedule display device according to the present invention.

[FIG. 8] It depicts an explanatory diagram illustrating an exemplary typical schedule table.

### DESCRIPTION OF EMBODIMENTS

An exemplary embodiment according to the present invention will be described with reference to the drawings. FIG. 1 is a block diagram illustrating a structure of a schedule display device according to the present exemplary embodiment.

As illustrated in FIG. 1, the schedule display device according to the present exemplary embodiment includes an input unit 1, a display processing unit 2, and a display unit 3.

The input unit 1 receives user's input operations. The input unit 1 is a touch panel used for a portable terminal such as smartphones.

The display processing unit 2 displays a schedule table on the display unit 3 by use of an image indicating a 3D object. The 3D object is a spiral belt, for example. Further, the display processing unit 2 changes display contents of the schedule table in response to a user's operation. The display processing unit 2 is realized in hardware designed to conduct specific calculation processings, or an information processing apparatus such as CPU (Central Processing Unit) operating according to a schedule display program, for example.

The display unit 3 displays display contents received from the display processing unit 2. The display unit 3 is a liquid crystal display of a portable terminal, for example.

The operations of the schedule display device according to the present exemplary embodiment will be described below. FIG. 2 is a flowchart illustrating the operations of the schedule display device according to the present exemplary embodiment.

The display processing unit 2 performs initial display of a schedule table in response to a user's operation (step S1). When a schedule display program installed in the portable terminal is activated, for example, the display processing unit 2 performs initial display of the schedule table.

FIG. 3 is an explanatory diagram illustrating exemplary display of a schedule table. As illustrated in FIG. 3, the display processing unit 2 displays the schedule table by use of a spiral belt. One-day schedules are displayed in each stage in the spiral. The display processing unit 2 may express the schedules to be displayed by icons or symbols, for example. With such a display method, the user can recognize the schedule contents even at short time width of the items displayed as schedules.

Further, the display processing unit 2 displays the items on the front side in one-day schedules to be wider width per unit time. For example, in the example illustrated in FIG. 3, the time zone from 9:00 to 15:00 displayed on the front side is wider in its unit time than the time zones from 6:00 to 9:00 and 15:00 to 18:00. Therefore, the user can easily view the contents described in the items displayed on the front side, and can easily operate the same. Especially when the input unit 1 is a touch panel, the user operates the same with his/her fingers, and thus the items on the front side are difficult to operate when the operation range is narrow, but can be easily operated with such display.

Further, the display processing unit 2 displays five times including 6:00, 9:00, 12:00, 15:00, and 18:00 in the belt in FIG. 3 as the times to be displayed in the schedule table, but is not limited to such display method. The display processing unit 2 may display the times per hour, for example, or may be displayed on the belt, not being overlapped on the band.

Further, the display processing unit 2 makes a range displayed on the front side of a predetermined position in the uppermost stage into an active state where the schedule items are operable. Moreover, the display processing unit 2 makes other part in the schedule table into an inactive state where the schedule items are not operable. In the example illustrated in FIG. 3, the part from 9:00 to 18:00 on Monday, March 4 is in the active state. Additionally, the display processing unit 2 displays the part in the active state (active part) in a different color from other part . Therefore, the user can easily determine the active state. In the example illustrated in FIGS. 3, 9:00 to 18:00 on Monday, March 4 is in the active state, but the user can arbitrarily set a range in the active state. The display processing unit 2 may make the whole range displayed on the front side of a predetermined position into the active state, not limited to the uppermost stage, for example.

When a schedule item in the active part other than its edge is operated (YES in step S2 or NO in step S3), the display processing unit 2 displays detailed contents of the schedule item. In the example illustrated in FIG. 3, when a part describing task 1 therein is pressed, the display processing unit 2 displays detailed contents of task 1.

FIG. 4 is an explanatory diagram illustrating exemplary display of detailed contents of a schedule. When an item in the active state other than its edge is pressed, as illustrated in FIG. 4, the display processing unit 2 displays the detailed contents of the schedule at the upper left of the screen. A place where detailed contents of a schedule are displayed is not limited to the upper left of the screen, and may be other places.

When an edge of a schedule item in the active state is operated (YES in step S2 or YES in step S3), the display processing unit 2 changes a display width of the schedule item (step S5). That is, the display processing unit 2 changes a time zone of the operated schedule item. In the example illustrated in FIG. 3, when the user operates to shift an edge of a schedule item to the right side, the time (start time or end time) is delayed, and when the user operates to shift an edge of the schedule item to the left, the time (start time or end time) is put ahead. In the example illustrated in FIG. 3, when the user shifts a line indicating 12:00 as the start time of task 1 or a line indicating 15:00 as the end time thereof, the display processing unit 2 changes the start time or end time of task 1.

FIG. 5 is an explanatory diagram illustrating an exemplary screen in which a schedule time is changed. In the screen illustrated in FIG. 5, the start time of task 1 is delayed by one hour than that on the screens illustrated in FIG. 3 and FIG. 4. The active part is displayed large on the front side, and thus the user can easily change the display width.

When apart in the inactive state where the schedule items are not operable (inactive part) is operated (YES in step S6), the display processing unit 2 changes a display form of the 3D object (step S7). Specifically, when the user laterally traces the inactive part (in the time axis direction), the display processing unit 2 rotates the 3D object along the trace direction. Thereby, the display processing unit 2 changes a time zone to be displayed on the front side. Thus, the user can move a desired time zone to the front side. Further, the active part is determined depending on a display position, and thus the user can freely change the active part.

When the user traces the inactive part in the schedule table upward or downward, the display processing unit 2 changes the dates to be displayed on the schedule table. Specifically, when the user traces the inactive part upward, the display processing unit 2 displays the future dates, and when the user traces the inactive part downward, the display processing unit 2 displays the past dates while a current date is being displayed. Thereby, the user can freely change the dates to be displayed.

When the user presses a lower part of the spiral with a finger and traces the spiral upward with other finger, for example, the display processing unit 2 hides some stages displayed at the upper part of the spiral thereby to reduce the number of stages to be displayed and to increase the width of the band. Further, when the user presses an upper part of the spiral with a finger and traces the spiral downward with other finger, for example, the display processing unit 2 hides some stages displayed at the lower part of the spiral thereby to reduce the number of stages to be displayed and to thicken the width of the band.

The user may reversely perform the above operations in order to increase the number of stages and to thin the width of the band. For example, when the user presses a lower part of the spiral with a finger and traces the spiral downward with other finger, the display processing unit 2 displays the schedules hidden above thereby to increase the number of stages and to thin the width of the band. When the user presses an upper part of the spiral with a finger and traces the spiral upward with other finger, the display processing unit 2 displays the schedules hidden below thereby to increase the number of stages and to thin the width of the band.

FIG. 6 is an explanatory diagram illustrating an exemplary screen in which the number of stages of the schedule table is changed. FIG. 6 illustrates a state after an upper part of the spiral is pressed with a finger and the spiral is traced downward in the screen state illustrated in FIG. 3. As illustrated in FIG. 6, the stages displaying March 7 and subsequent date at the lower part of the spiral in FIG. 3 are hidden and the width of the band is thicken. The width of the band is thickened so that the detailed contents are displayed per each schedule item. Thereby, the user can easily confirm the contents of the schedules. In order to return the state illustrated in FIG. 6 to the state illustrated in FIG. 3, the user may press an upper part of the spiral with a finger and trace the spiral upward with other finger.

Since a range in the active state in which the schedule items are operable is limited, the user can change the dates to be displayed or change the number of stages in the schedule table or the width of the band without erroneously operating a schedule item.

The schedule tables illustrated in FIG. 3 to FIG. 6 are displayed in a spiral belt, but any other 3D objects capable of displaying schedules may be employed. For example, the display processing unit 2 may display a schedule table on objects such as spherical object, column or several rings. The colors of a schedule table may be different per date.

With the schedule display device according to the present exemplary embodiment, the front side in a schedule table is displayed to be wider width per unit time, thereby displaying the schedule table with high operability and listing function.

With the schedule display device according to the present exemplary embodiment, the items on the front side are displayed larger, which causes an advantage that the user can easily operate especially when the input unit 1 is a touch panel. Further, a scroll bar does not need to be displayed, and thus it is possible to prevent an erroneous operation such as changing a schedule item when the user tries to operate the scroll bar.

With the schedule display device according to the present exemplary embodiment, only a range displayed on the front side of a predetermined position is assumed in the active state in which the schedule items are operable. Further, the schedule items displayed on the front side are displayed larger, and thus it is possible for the user to prevent an erroneous operation such as operating the items other than an item which the user wants to operate.

FIG. 7 is a block diagram illustrating a structure of main components in the schedule display device according to the present invention. As illustrated in FIG. 7, the schedule display device includes the display processing unit 2 for displaying a schedule table by use of an image indicating a 3D object on a screen of a portable terminal, and the display processing unit 2 displays the schedule items on the front side of the object to be wider width per unit time.

The above exemplary embodiment discloses the schedule display device described in the following (1) to (5).

(1) A schedule display device in which a display processing unit (the display processing unit 2, for example) makes a part on the front side of a predetermined position in a schedule table into an active state in which schedule items are operable, and makes other part in the schedule table into an inactive state in which the schedule items are not operable. With the schedule display device, the user can easily view the contents described in the items displayed on the front side and can easily operate the same. Especially when the input unit is a touch panel, the items on the front side in such display are easy to operate since the user operates with fingers, although the narrow operation range is difficult to operate.

(2) The schedule display device may be configured such that when a schedule item in the active state other than its edge is operated, the display processing unit displays more detailed contents of the schedule item than the already-displayed contents thereof.

(3) The schedule display device may be configured such that when an edge of a schedule item in the active state is operated, the display processing unit changes a time zone of the schedule item.

(4) The schedule display device may be configured such that when a part in the inactive state in which the schedule items are not operable is operated, the display processing unit operates the schedule table thereby to change the display form of the 3D object. With the schedule display device, the user can move his/her desired time zone to the front side. Further, the active part is determined depending on a display position, and thus the user can freely change the active part.

(5) The schedule display device may be configured such that the display processing unit displays a schedule table by use of an image indicating a 3D object on a screen of a portable terminal operated via a touch panel, and when a part in the inactive state is operated to trace, rotates the 3D object along the trace direction thereby to change a time zone to be displayed on the front side.

The present application claims the priority based on Japanese Patent Application No. 2013-058224 filed on Mar. 21, 2013, the disclosure of which is all incorporated herein by reference.

The present invention has been described above by way of the exemplary embodiment, but the present invention is not limited to the exemplary embodiment. The structure and details of the present invention may be variously modified within the scope of the present invention understandable by those skilled in the art.

### INDUSTRIAL APPLICABILITY

The present invention is applicable to smartphones or tablet terminals.

### REFERENCE SIGNS LIST

1 Input unit

2 Display processing unit

3 Display unit

1. A schedule display device comprising:
a display processing unit for displaying a schedule table by use of an image indicating a 3D object on a screen of a portable terminal,
wherein the display processing unit displays schedule items on the front side of the object to be wider width per unit time.

2. The schedule display device according to claim 1,
wherein the display processing unit makes a part on the front side of a predetermined position in a schedule table into an active state in which schedule items are operable, and makes other part in the schedule table into an inactive state in which the schedule items are not operable.

3. The schedule display device according to claim 2,
wherein when a schedule item in the active state other than its edge is operated, the display processing unit displays more detailed contents of the schedule item than the already-displayed contents thereof.

4. The schedule display device according to claim 2,
wherein when an edge of a schedule item in the active state is operated, the display processing unit changes a time zone of the schedule item.

5. The schedule display device according to claim 2,
wherein when a part in the inactive state is operated, the display processing unit changes a display form of a 3D object.

6. The schedule display device according to claim 5,
wherein the display processing unit displays a schedule table by use of an image indicating a 3D object on a screen of a portable terminal operated via a touch panel, and when a part in the inactive state is operated to trace, rotates the 3D object along the trace direction thereby to change a time zone to be displayed on the front side.

7. A schedule display method comprising:
displaying a schedule table by use of an image indicating a 3D object on a screen of a portable terminal; and
displaying schedule items on the front side of the object to be wider width per unit time.

8. The schedule display method according to claim 7,
wherein making a part on the front side of a predetermined position in a schedule table into an active state in which schedule items are operable, and making another part in the schedule table into an inactive state in which the schedule items are not operable.

9. A non-transitory computer readable information recording medium storing a schedule display program that, when executed by a processor, performs a method for:
displaying a schedule table by use of an image indicating a 3D object on a screen of a portable terminal and displaying schedule items on the front side of the object to be wider width per unit time.

10. The non-transitory computer readable information recording medium storing a schedule display program according to claim 9, the program that, when executed by a processor, performs a method for:
making a part on the front side of a predetermined position in a schedule table into an active state in which schedule items are operable, and making other part in the schedule table into an inactive state in which the schedule items are not operable.

11. The schedule display device according to claim 3,
wherein when an edge of a schedule item in the active state is operated, the display processing unit changes a time zone of the schedule item.

12. The schedule display device according to claim 3,
wherein when a part in the inactive state is operated, the display processing unit changes a display form of a 3D object.

13. The schedule display device according to claim 4,
wherein when a part in the inactive state is operated, the display processing unit changes a display form of a 3D object.
